(19) United States
(12) Patent Application Publication
(10) Pub. No.: US 2017/0122397 A1
(43) Pub. Date: May 4, 2017

(54) MAGNETIC RHEOLOGICAL FLUID SHOCK ABSORBER

(71) Applicant: KYB Corporation, Tokyo (JP)

(72) Inventor: Keiji Saito, Tokyo (JP)

(73) Assignee: KYB Corporation, Tokyo (JP)

(21) Appl. No.: 15/125,990

(22) PCT Filed: Mar. 13, 2015
(86) PCT No.: PCT/JP2015/057443

§ 371 Date: Sep. 14, 2016

(30) Foreign Application Priority Data
Mar. 18, 2014 (JP) 2014-055041

(51) Int. Cl. F16F 9/53; F16F 9/32; B60G 17/08

(52) U.S. Cl. CPC F16F 9/535; B60G 17/08; F16F 9/3207; B60G 2600/22; B60G 2202/24; B60G 2206/41; B60G 2500/10; F16F 2228/06; F16F 2222/06; F16F 2224/045

(57) ABSTRACT

A piston of a magnetic rheological fluid shock absorber comprises a piston core that is formed from a magnetic material and is provided with a coil on the outer periphery thereof, and a ring body that is formed from a magnetic material, surrounds the outer periphery of the piston core. A flow path of the magnetic rheological fluid is formed between the ring body and the piston core. The flow path of the magnetic rheological fluid comprises a first flow path part having a predetermined cross-sectional flow area, and a second flow path part having a larger cross-sectional flow area than the predetermined cross-sectional flow area and a longer axial length than the coil to cover the outer periphery of the coil.

### TECHNICAL FIELD

The present invention relates to a magnetic rheological fluid shock absorber utilizing a magnetic rheological fluid in which an apparent viscosity changes due to the action of a magnetic field.

### BACKGROUND ART

A vehicle such as an automobile may be provided with shock absorbers in which a magnetic field is applied to a flow path through which a magnetic rheological fluid passes. A damping force of the shock absorbers changes by changing an apparent viscosity of the magnetic rheological fluid. JP2008-175364A discloses a magnetic rheological fluid shock absorber comprising a piston assembly including a piston core and a piston ring slides within the cylinder. The piston core has a coil wrapped around the outer periphery thereof and the piston ring is disposed on the outer periphery of the piston core. When the piston assembly slides within the cylinder, a magnetic rheological fluid passes through a flow path formed between the piston core and the piston ring.

### SUMMARY OF INVENTION

In the above-described magnetic rheological fluid shock absorber, the damping force when the coil is not energized is determined by a pressure loss according to the length of the flow path. Therefore, if the flow path is long, the pressure loss increases and the minimum value of the damping force increases, and thus an adjustment range of the damping force when the coil is energized may decrease accordingly.

It is therefore an object of the present invention to increase the adjustment range of the damping force in a magnetic rheological fluid shock absorber.

In order to achieve the above object, the present invention provides a magnetic rheological fluid shock absorber utilizing a magnetic rheological fluid that changes a viscosity according to a magnetic field applied.

The shock absorber comprises a cylinder in which a magnetic rheological fluid is enclosed, a piston disposed within the cylinder to slide therein and defining a pair of fluid chambers within the cylinder, and a piston rod connected to the piston and extending to an outside of the cylinder. The piston comprises a piston core formed from a magnetic material and provided with a coil on an outer periphery thereof, and a ring body formed from a magnetic material and surrounding an outer periphery of the piston core. The ring body and the piston core form a flow path of the magnetic rheological fluid there-between.

The flow path comprises a first flow path part having a predetermined cross-sectional flow area, and a second flow path part having a larger cross-sectional flow area than the predetermined cross-sectional flow area and a longer axial length than the coil to cover an outer periphery of the coil.

### BRIEF DESCRIPTION OF DRAWINGS

FIG. 1 is a longitudinal sectional view of a magnetic rheological fluid shock absorber according to an embodiment of the present invention;

FIG. 2 is a front view of a piston seen from left side of FIG. 1;

FIG. 3 is a rear view of the piston seen from right side of FIG. 1; and FIG. 4 is a diagram explaining a magnetic flux density of a magnetic field formed around a coil.

FIG. 5 is similar to FIG. 1 but showing another embodiment of the present invention.

FIG. 6 is similar to FIG. 1 but showing yet another embodiment of the present invention.

### DESCRIPTION OF EMBODIMENTS

Embodiments of the present invention will now be explained below referring to the drawings.

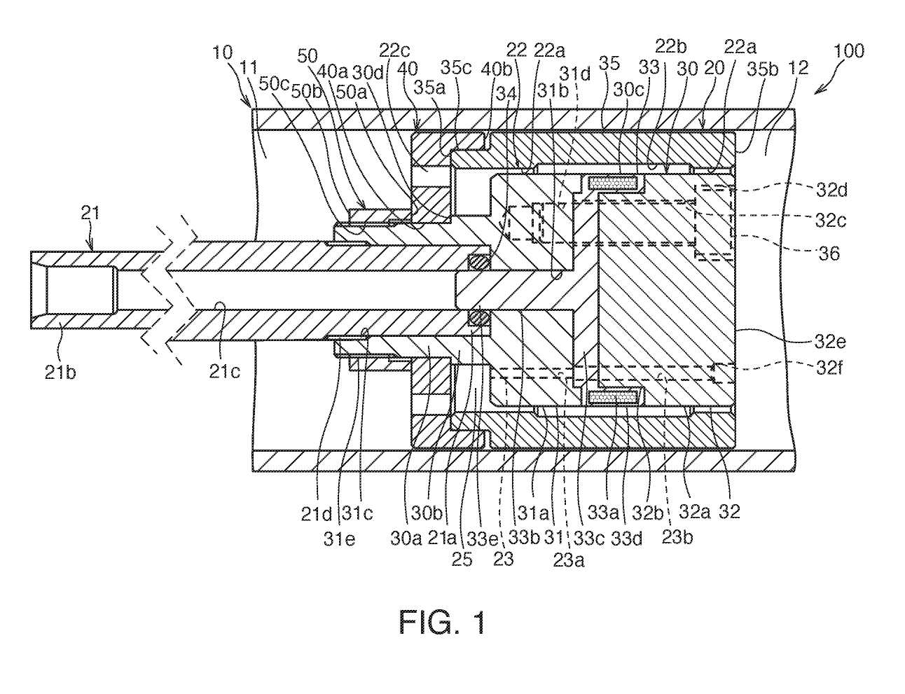

Referring to FIG. 1 of the drawings, the overall structure of a magnetic rheological fluid shock absorber (hereinafter referred to simply as a “shock absorber”) 100 according to an embodiment of the present invention will be explained.

The shock absorber 100 is a damper in which a damping coefficient can be changed by using a magnetic rheological fluid in which the viscosity changes due to the action of a magnetic field. The shock absorber 100 is, for example, interposed between a vehicle body and an axle in a vehicle such as an automobile. The shock absorber 100 generates a damping force that suppresses vibrations of the vehicle body by an extending/contracting operation.

The shock absorber 100 comprises a cylinder 10 in which a magnetic rheological fluid is enclosed, a piston 20 that slides within the cylinder 10, and a piston rod 21 connected to the piston 20 and extends to the outside of the cylinder 10.

The cylinder 10 is formed in a closed-end cylindrical shape. The apparent viscosity of the magnetic rheological fluid enclosed in the cylinder 10 changes due to the action of a magnetic field. The magnetic rheological fluid is a fluid such as oil in which ferromagnetic fine particles are dispersed. The viscosity of the magnetic rheological fluid changes according to the strength of the magnetic field that is acting upon it, and the viscosity returns to its original state when the effect of the magnetic field disappears.

Within the cylinder 10, a gas chamber (not illustrated) in which a gas is enclosed is defined by a free piston (not illustrated). A change in capacity in the cylinder 10 caused by the ingression and retraction of the piston rod 21 is compensated by providing the gas chamber.

The piston 20 defines a fluid chamber 11 and a fluid chamber 12 within the cylinder 10. The piston 20 includes an annular flow path 22 through which the magnetic rheological fluid can move between the fluid chamber 11 and the fluid chamber 12, and a bypass flow path 23 constituted by a through-hole. The piston 20 can slide within the cylinder 10 by causing the magnetic rheological fluid to pass through the flow path 22 and the bypass flow path 23. The structure of the piston 20 will be explained later in further detail.

The piston rod 21 is formed coaxially with the piston 20. The piston rod 21 is fixed at one end 21a to the piston 20, and the other end 21b extends to the outside of the cylinder 10. The piston rod 21 is formed in a cylindrical shape in which the one end 21a and the other end 21b are opened. A pair of wirings (not illustrated) that supply an electric current to a coil 33a of the piston 20, which will be explained later, pass along an inner periphery 21c of the piston rod 21. Male threads 21d that is screwed into the piston 20 are formed on the outer periphery near the one end 21a of the piston rod 21.

Next, referring to FIGS. 1 to 4, the structure of the piston 20 will be explained.

The piston 20 has a piston core 30 provided with the coil 33a on the outer periphery thereof, a flux ring 35 serving as a ring body that surrounds the outer periphery of the piston core 30 and forms the flow path 22 of the magnetic rheological fluid between itself and the piston core 30, a plate 40 that is formed annularly and is attached to one end 35a of the flux ring 35, and a fixing nut 50 serving as a stopper that sandwiches the plate 40 between itself and the piston core 30.

The piston core 30 is formed in an approximately circular column shape by a magnetic material. The piston core 30 has a small diameter part 30a that is attached to an end of the piston rod 21, an expanded diameter part 30b that is formed to be axially continuous with the small diameter part 30a but with a comparatively larger diameter and forms a stepped part 30d between itself and the small diameter part 30a, and a large diameter part 30c that is formed to be axially continuous with the expanded diameter part 30b but with a comparatively larger diameter and is provided with the coil 33a on the outer periphery thereof.

The piston core 30 has a first core 31 attached to an end of the piston rod 21, a coil assembly 33 provided with the coil 33a on the outer periphery thereof, a second core 32 that sandwiches the coil assembly 33 between itself and the first core 31, and a pair of bolts 36 serving as fastening members that fasten the second core 32 and the coil assembly 33 to the first core 31.

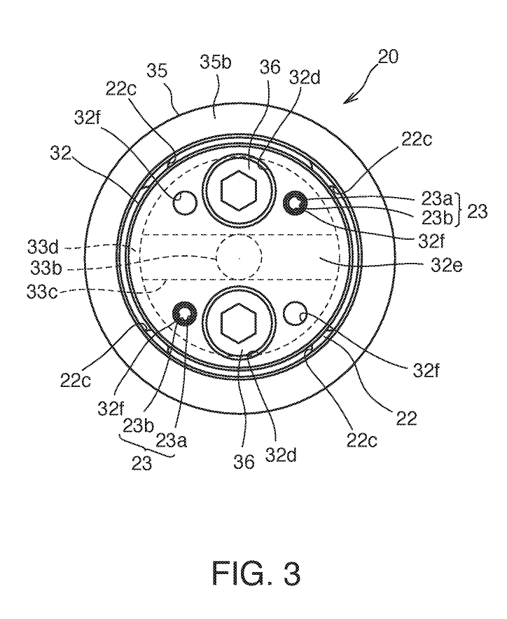

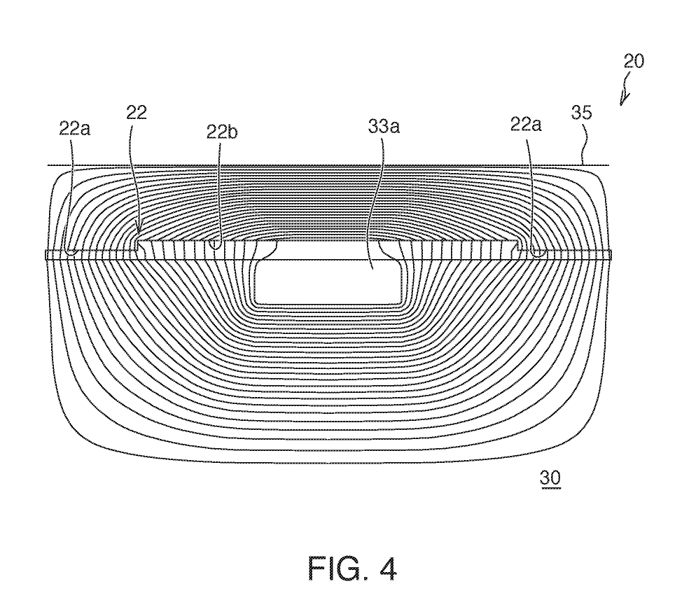

The piston core 30 also has the bypass flow path 23 that is formed to penetrate axially at a position where the effect of the magnetic field generated by the coil 33a is less than that in the flow path 22. The bypass flow path 23 is constituted by a through-hole 23a that penetrates the first core 31, and a through-hole 23b that penetrates the second core 32. As shown in FIG. 3, there are two bypass flow paths 23 formed at two locations spaced apart by 180°. However, the bypass flow path 23 is not limited to this configuration, and the number of bypass flow paths 23 may be arbitrarily determined. It is also possible not to provide the bypass flow path 23.

The first core 31 has the small diameter part 30a, the expanded diameter part 30b, a large diameter part 31a that forms a portion of the large diameter part 30c of the piston core 30, a through-hole 31b that axially penetrates the center of the first core 31, and the through-holes 23a that form a portion of the bypass flow paths 23.

The small diameter part 30a is formed in a cylindrical shape to protrude axially from the plate 40. Female threads 31c that is screwed to the male threads 21 d of the piston rod 21 are formed on the inner periphery of the small diameter part 30a. The piston core 30 is fastened to the piston rod 21 by engaging the male threads 21d and the female threads 31c.

The expanded diameter part 30b is formed in a cylindrical shape. The expanded diameter part 30b is formed coaxially and continuously with the small diameter part 30a. The annular stepped part 30d is formed between the small diameter part 30a and the expanded diameter part 30b. The plate 40 abuts the stepped part 30d, and the plate 40 is sandwiched between the stepped part 30d and the fixing nut 50. Male threads 31e that engage with female threads 50c of the fixing nut 50 in a state in which the plate 40 is sandwiched are formed on the outer periphery at a distal end of the small diameter part 30a.

The large diameter part 31a is formed in a cylindrical shape. The large diameter part 31a is formed coaxially and continuously with the expanded diameter part 30b. The outer periphery of the large diameter part 31a faces the flow path 22 through which the magnetic rheological fluid passes. The large diameter part 31a abuts the coil assembly 33 and the second core 32. A cylindrical part 33b of the coil assembly 33, which will be explained later, is inserted and fitted into the through-hole 31b of the large diameter part 31a. A pair of female-threaded holes 31d that engage with the bolts 36 is formed on the large diameter part 31a.

The through-holes 23a axially penetrate the large diameter part 31a of the first core 31. As shown in FIG. 3, there are two through-holes 23a formed at two locations spaced apart by 180°. The damping characteristics during sliding of the piston 20 depend on the hole diameter of the through-holes 23a.

The second core 32 has a large diameter part 32a that forms a portion of the large diameter part 30c of the piston core 30, a small diameter part 32b that is formed on one end of the large diameter part 32a with a smaller diameter than the large diameter part 32a, through-holes 32c which allow the bolts 36 to penetrate, counterbore parts 32d in which the heads of the bolts 36 are accommodated, the through-holes 23b that form a portion of the bypass flow paths 23, and a plurality of tool holes 32f with which a tool for rotating the piston 20, not illustrated, engages.

The large diameter part 32a is formed in a circular column shape. The large diameter part 32a is formed coaxially with the large diameter part 31a of the first core 31. The outer periphery of the large diameter part 32a faces the flow path 22 through which the magnetic rheological fluid passes. The large diameter part 32a is formed such that an end surface 32e facing the fluid chamber 12 is flush with the other end 35b of the flux ring 35.

The small diameter part 32b is formed in a circular column shape to be coaxial with the large diameter part 32a. The small diameter part 32b is formed with the same diameter as the inner periphery of a coil mold 33d of the coil assembly 33, which will be explained later, and is fitted into the inner periphery of the coil mold 33d. A groove that extends linearly in the radial direction corresponding to a connecting part 33c of the coil assembly 33, which will be explained later, is formed in the end surface of the small diameter part 32b.

A pair of the through-holes 32c penetrate axially the second core 32. The through-holes 32c are formed to have a larger diameter than the diameter of the threaded parts of the bolts 36. The through-holes 32c are formed to be coaxial with the female-threaded holes 31d of the first core 31 in an assembled state of the piston core 30.

The counterbore parts 32d are formed on the ends of the through-holes 32c. The counterbore parts 32d are formed to be larger in diameter than the through-holes 32c, and to be larger in diameter than the heads of the bolts 36. The counterbore parts 32d are formed with a depth that can completely accommodate the heads of the bolts 36. When the bolts 36 inserted into the through-holes 32c are screwed into the female-threaded holes 31d of the first core 31, the bottom surfaces of the counterbore parts 32d are pressed towards the first core 31, and thereby the second core 32 is pressed to the first core 31.

The through-holes 23b are formed to be larger in diameter than the through-holes 23a. As shown in FIG. 3, there are two through-holes 23b formed at two locations spaced apart by 180°. The through-holes 23b are formed to be coaxial with the through-holes 23a in an assembled state of the piston core 30. The damping characteristics during sliding of the piston 20 are determined by the hole diameter of the through-holes 23a. The hole diameter of the through-holes 23b does not affect the damping characteristics during sliding of the piston 20.

The tool holes 32f are holes into which the tool is fitted to cause the piston 20 to be screwed onto the piston rod 21. As shown in FIG. 3, there are four tool holes 32f formed at four locations spaced apart by 90°. In the present embodiment, two of the four tool holes 32f are formed on the ends of the through-holes 23b. In this way, the tool holes 32f are common with the through-holes 23b.

The coil assembly 33 is formed by molding a resin in a state in which the coil 33a is fitted. The coil assembly 33 has the cylindrical part 33b that engages with the through-hole 31b of the first core 31, the connecting part 33c that is sandwiched between the first core 31 and the second core 32, and the coil mold 33d provided with the coil 33a therein.

The coil 33a forms a magnetic field by supplying an electric current from outside. The strength of the magnetic field increases as the electric current supplied to the coil 33a increases. When the electric current is supplied to the coil 33a and the magnetic field is formed, the apparent viscosity of the magnetic rheological fluid flowing through the flow path 22 changes. The viscosity of the magnetic rheological fluid increases as the strength of the magnetic field generated by the coil 33a increases.

A distal end 33e of the cylindrical part 33b engages with the inner periphery of the piston rod 21. A pair of wirings for supplying the electric current to the coil 33a is extracted from the distal end of the cylindrical part 33b. An O-ring 34 serving as a sealing member is provided between the distal end 33e of the cylindrical part 33b and the one end 21a of the piston rod 21.

The O-ring 34 is compressed axially by the large diameter part 31a of the first core 31 and the piston rod 21, and is compressed radially by the distal end 33e of the coil assembly 33 and the piston rod 21. Thereby, magnetic rheological fluid that has penetrated between the outer periphery of the piston rod 21 and the first core 31 or between the first core 31 and the coil assembly 33 is prevented from leaking to the inner periphery of the piston rod 21.

The connecting part 33c is formed into a linear bar shape that extends radially from a base end of the cylindrical part 33b as a center. The connecting part 33c connects two locations of the coil mold 33d and the cylindrical part 33b. The pair of wirings that supply electric current to the coil 33a passes through the inside of the connecting part 33c and the cylindrical part 33b. The female-threaded holes 31d of the first core 31 and the through-holes 23a, as well as the through-holes 32c of the second core 32 and the through-holes 23b are formed at positions that do not interfere with the connecting part 33c.

The coil mold 33d is formed annularly to stand up from radial both ends of the connecting part 33c. The coil mold 33d projects axially from an axial end of the connecting part 33c that is opposite to the cylindrical part 33b of the coil assembly 33. The coil mold 33d is formed to have the same diameter as the large diameter part 31a of the first core 31. The outer periphery of the coil mold 33d forms a portion of the large diameter part 30c of the piston core 30. The coil 33a is accommodated inside of the coil mold 33d.

In this way, the piston core 30 is divided into the three members, i.e., the first core 31, the second core 32, and the coil assembly 33. According to this construction, only the coil assembly 33 onto which the coil 33a is fitted is formed by molding and then sandwiched between the first core 31 and the second core 32. Manufacturing the piston core 30 is thereby rendered easy compared to a case of performing a molding operation to form the piston core 30 as a single unit.

Instead of constituting the piston core 30 by the three members of the first core 31, the second core 32, and the coil assembly 33, the piston 20 may be constituted by only two members by integrally forming the first core 31 and the coil assembly 33. Alternatively, the second core 32 and the coil assembly 33 may be integrally formed to constitute the piston 20 by only two members.

In the piston core 30, the first core 31 is fixed to the piston rod 21, but the coil assembly 33 and the second core 32 are merely fitted together axially. Thus, in the piston 20, the second core 32 and the coil assembly 33 are pressed against the first core 31 so as to be fixed together by tightening the pair of bolts 36 into the female-threaded holes 31d.

The bolts 36 penetrate the through-holes 32c of the second core 32 and screwed into the female-threaded holes 31d of the first core 31. The bolts 36 press the bottom surfaces of the counterbore parts 32d toward the first core 31 by the tightening force thereof. The coil assembly 33 is thereby sandwiched between the second core 32 and the first core 31, and thus the piston core 30 is integrated.

In this way, the second core 32 and the coil assembly 33 are pressed against the first core 31 to be fixed together by simply tightening the bolts 36, and thus the piston core 30 can be easily assembled.

The flux ring 35 is formed in an approximately cylindrical shape by a magnetic material. The outer periphery of the flux ring 35 is formed to have approximately the same diameter as the inner periphery of the cylinder 10. The inner periphery of the flux ring 35 faces the outer periphery of the piston core 30. The inner periphery of the flux ring 35 is formed to be larger in diameter than the outer periphery of the piston core 30 such that the flow path 22 is formed between the flux ring 35 and the piston core 30. The flux ring 35 is fixed to the piston core 30 via the plate 40 so that the flux ring 35 is coaxial with the piston core 30.

The flux ring 35 has a small diameter part 35c formed at one end 35a to which the plate 40 is fitted. The small diameter part 35c is formed to be smaller in diameter than the other portions of the flux ring 35 so that the plate 40 is fitted onto the outer periphery thereof.

The flow path 22 has a first flow path part 22a formed with a predetermined cross-sectional flow area, and a second flow path part 22b formed to have a larger cross-sectional flow area than the first flow path part 22a and a longer axial length than the coil 33a to cover the outer periphery of the coil 33a.

Two first flow path parts 22a are formed at both ends of the flow path 22. The first flow path parts 22a are formed to be continuous with both ends of the second flow path part 22b. The first flow path parts 22a are formed to have a same length. It is also possible to form only a single first flow path part 22a to be continuous with only one end of the second flow path part 22b. In the first flow path parts 22a, the magnetic flux density of the magnetic field generated by the coil 33a is higher than in the second flow path part 22b because the distance between the piston core 30 and the flux ring 35 is smaller compared to the second flow path part 22b (refer to FIG. 4).

By forming the first flow path parts 22a at both ends of the second flow path part 22b, the magnetic gap can be reduced. Thus, a magnetic circuit with good efficiency can be formed. Further, by making the lengths of the pair of first flow path parts 22a the same, a magnetic circuit with even better efficiency can be formed.

The second flow path part 22b is formed between the pair of first flow path parts 22a. In the second flow path part 22b, the distance between the piston core 30 and the flux ring 35 is larger compared to that in the first flow path parts 22a. Thus, the magnetic flux density of the magnetic field generated by the coil 33a is relatively low (refer to FIG. 4). Both ends of the second flow path part 22b are continuous with the first flow path parts 22a.

The second flow path part 22b is formed in a position to face the outer periphery of the coil 33a and the outer periphery of the piston core 30 at both ends of the coil 33a. By forming the second flow path part 22b in the position to face the outer periphery of the piston core 30 at both ends of the coil 33a, the magnetic flux density of the second flow path part 22b can be increased compared to the case in which the second flow path part 22b is formed only in a position to face the outer periphery of the piston core 30 at one end of the coil 33a. However, the present invention is not limited thereto, and the second flow path part 22b may be formed only in the position to face the outer periphery of the coil 33a and the outer periphery of the piston core 30 at one end of the coil 33a.

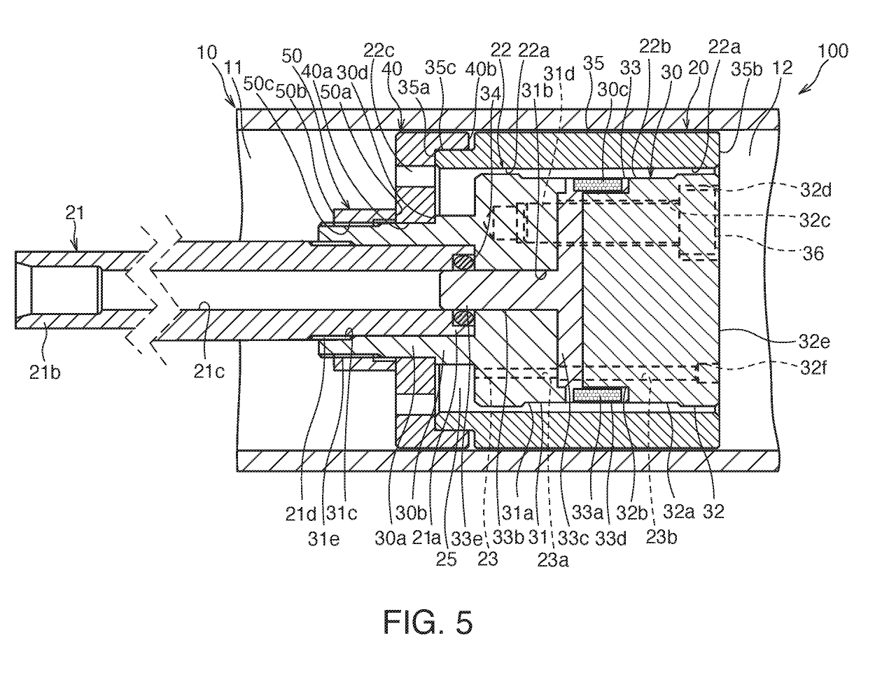

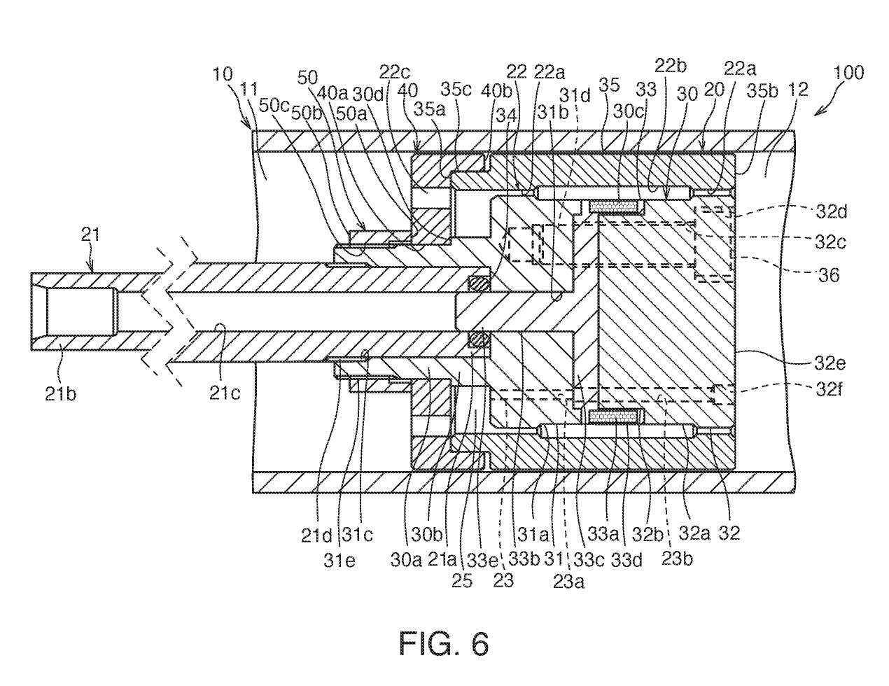

The second flow path part 22b is formed with an expanded diameter compared to that of the first flow path parts 22a by an annular recess formed on the inner periphery of the flux ring 35. In this case, it is easier to increase the cross-sectional flow area of the second flow path part 22b. However, the present invention is not limited thereto, and an annular recess can be formed on the outer periphery of the piston core 30 as shown in FIG. 5. In this case, the machining is easier compared to forming the annular recess on the inner periphery of the flux ring 35. Further, an annular recess can be formed on both the flux ring 35 and the piston core 30 as shown in FIG. 6.

The coil 33a is formed in the axial center of the second flow path part 22b. As explained above, the pair of first flow path parts 22a is formed to have the same length as each other. Thus, the flow path 22 has a symmetrical shape in the longitudinal direction centered on the coil 33a.

The plate 40 supports and defines the axial direction position of the one end 35a of the flux ring 35 relative to the piston core 30. The outer periphery of the plate 40 is formed to have the same diameter or a smaller diameter than the outer periphery of the flux ring 35.

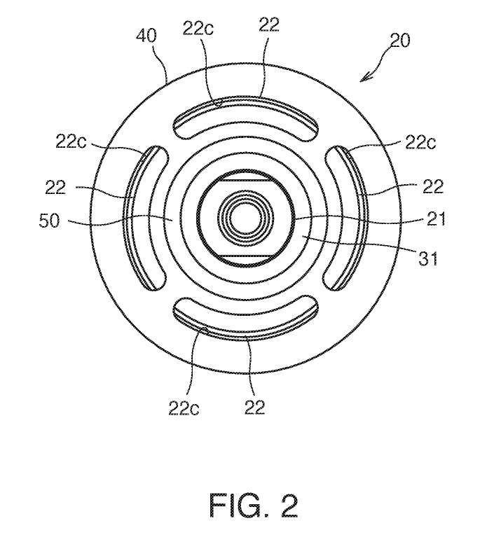

As shown in FIG. 2, the plate 40 has a plurality of flow paths 22c, which are through-holes in communication with the flow path 22. The flow paths 22c are formed in an arc shape and are disposed at equal angle intervals. In the present embodiment, four flow paths 22c are formed at 90° intervals. The flow paths 22c are not limited to a arc shape, and can be formed as, for example, a plurality of circular through-holes.

A bypass branching path 25 that leads magnetic rheological fluid that has flowed in from the flow paths 22c to the bypass flow path 23 is formed between the plate 40 and the large diameter part 30c of the piston core 30. The bypass branching path 25 is an annular cavity formed on the outer periphery of the expanded diameter part 30b.

The magnetic rheological fluid that has flowed from the flow paths 22c into the piston core 30 flows to the flow path 22 and the bypass flow paths 23 via the bypass branching path 25. Therefore, it is not necessary to match the relative positions in the peripheral direction of the flow paths 22c and the bypass flow paths 23, and thus the assembly of the piston 20 is easy.

A through-hole 40a into which the small diameter part 30a of the first core 31 is fitted is formed on the inner periphery of the plate 40. The concentricity of the plate 40 and the first core 31 is assured by fitting the small diameter part 30a into the through-hole 40a.

An cylindrical part 40b that is fitted onto the small diameter part 35c of the one end 35a of the flux ring 35 is formed on the outer periphery of the plate 40. The cylindrical part 40b is formed to project in the axial direction toward the flux ring 35. The cylindrical part 40b is fixed by brazing to the small diameter part 35c. Instead of brazing, the plate 40 and the flux ring 35 can be fixed together by welding, screwing, or the like.

The plate 40 is pressed to the stepped part 30d and sandwiched by the fastening force of the fixing nut 50 on the small diameter part 30a of the piston core 30. Thereby, the position in the axial direction relative to the piston core 30 of the flux ring 35 that is fixed to the plate 40 is defined.

The fixing nut 50 is formed in an approximately cylindrical shape and is screwed onto the outer periphery of the small diameter part 30a of the piston core 30. A distal end 50a of the fixing nut 50 abuts the plate 40. Female threads 50c that engage with the male threads 31e of the first core 31 are formed on the inner periphery of a base end 50b of the fixing nut 50. Thereby, the fixing nut 50 is screwed onto the small diameter part 30a.

As explained above, the plate 40 that is attached to the one end 35a of the flux ring 35 is sandwiched between the stepped part 30d of the piston core 30 that is attached to the end of the piston rod 21 and the fixing nut 50 screwed onto the small diameter part 30a. The flux ring 35 is thereby fixed to the piston core 30 in the axial direction. It is not necessary to provide another member that protrudes axially from the other end 35b of the flux ring 35 in order to define the axial direction position of the flux ring 35. Accordingly, the overall length of the piston 20 of the shock absorber 100 can be shortened.

The operation of the shock absorber 100 will be explained below.

When the shock absorber 100 extends/contracts and the piston rod 21 ingresses into/retracts from the cylinder 10, the magnetic rheological fluid flows through the flow path 22 and the bypass flow paths 23 via the flow paths 22c formed in the plate 40 and the bypass branching path 25. The magnetic rheological fluid moving between the fluid chamber 11 and the fluid chamber 12 enables the piston 20 to slide within the cylinder 10.

The first core 31 and the second core 32 of the piston core 30 and the flux ring 35 are formed from magnetic materials, and form a magnetic path that guides the magnetic flux generated around the coil 33a as shown in FIG. 4. The plate 40 is formed from a non-magnetic material. Therefore, the flow path 22 between the piston core 30 and the flux ring 35 becomes a magnetic gap through which the magnetic flux generated around the coil 33a passes. Accordingly, during extension/contraction of the shock absorber 100, the magnetic field of the coil 33a acts on the magnetic rheological fluid flowing through the flow path 22.

The flow path 22 is constituted by the first flow path parts 22a formed with the predetermined cross-sectional flow area, and the second flow path part 22b formed to have the larger cross-sectional flow area than that of the first flow path parts 22a and the longer axial length than the coil 33a to cover the outer periphery of the coil 33a. As shown in FIG. 4, the magnetic flux density of the magnetic field acting on the flow path 22 is high in the first flow path parts 22a which have a relatively small cross-sectional flow area but decreases in the second flow path part 22b which has the larger cross-sectional flow area.

Herein, when compared with a case in which the flow path 22 is formed without the second flow path part 22b so as to have a constant cross-sectional flow area, according to the present embodiment, the length of the first flow path parts 22a is short and thus the pressure loss is small. Therefore, the distance between the piston core 30 and the flux ring 35 in the first flow path parts 22a can be decreased, and the cross-sectional flow area can also be decreased. As a result, the magnetic flux density of the magnetic field in the first flow path parts 22a is increased, and the adjustment range of the damping force can be increased.

Further, according to the present embodiment, the magnetic field also acts on portions excluding the outer periphery of the coil 33a of the second flow path part 22b formed between the pair of the first flow path parts 22a. Therefore, the magnetic field acts on not only the first flow path parts 22a but also the second flow path part 22b, and thus the maximum value of the damping force can be increased.

As explained above, in the present embodiment, since the first flow path parts 22a where the pressure loss is large can be formed with a short length, the minimum value of the damping force when the coil 33a is not energized can be decreased. Further, when the coil 33a is energized, the magnetic field acts on not only the first flow path parts 22a but also on the portions excluding the outer periphery of the coil 33a of the second flow path part 22b, and thus the maximum value of the damping force can be increased. Therefore, the adjustment range of the damping force in the shock absorber 100 can be increased.

The damping force generated by the shock absorber 100 is adjusted by changing the amount of power supplied to the coil 33a to change the strength of the magnetic field acting on the magnetic rheological fluid flowing through the flow path 22. Specifically, as the current supplied to the coil 33a increases, the strength of the magnetic field generated around the coil 33a increases. Thus, the viscosity of the magnetic rheological fluid flowing through the flow path 22 increases, and thereby the damping force generated by the shock absorber 100 increases.

On the other hand, each bypass flow path 23 is constituted by the through-hole 23a formed in the first core 31 of the piston core 30 and the through-hole 23b formed in the second core 32 and the coil assembly 33. The annular bypass branching path 25 is defined between the piston core 30 and the plate 40. The bypass flow paths 23 communicate with the flow paths 22c via the bypass branching path 25 and have openings in the end surface 32e of the piston 20.

Each of the bypass flow paths 23 is defined by the through-hole 23a and the through-hole 23b that axially penetrate the piston core 30 made of a magnetic material. The coil 33a is fitted onto the outer periphery of the piston core 30. Accordingly, the magnetic rheological fluid flowing through the bypass flow paths 23 is not easily affected by the magnetic field of the coil 33a.

By providing the bypass flow paths 23, during extension/contraction of the shock absorber 100, pressure fluctuations generated when the current value of the coil 33a is adjusted by the flow path resistance are moderated. Therefore, the occurrence of impacts, noises, and the like due to sudden pressure fluctuations is prevented. In the shock absorber 100, the inner diameter and length of the through-hole 23a of each bypass flow path 23 are set according to the desired damping characteristics.

According to the above-described embodiments, the following effects are achieved.

The flow path 22 has the first flow path parts 22a formed to have a predetermined cross-sectional flow area, and the second flow path part 22b formed to have the larger cross-sectional flow area than that of the first flow path parts 22a and the longer axial length than the coil 33a to cover the outer periphery of the coil 33a. Accordingly, since the first flow path parts 22a where the pressure loss is large can be formed to have a short length, the minimum value of the damping force when the coil 33a is not energized can be decreased. Further, when the coil 33a is energized, the magnetic field acts on not only the first flow path parts 22a but also on the portions excluding the outer periphery of the coil 33a of the second flow path part 22b, and thus the maximum value of the damping force can be increased. Therefore, the adjustment range of the damping force in the shock absorber 100 can be increased.

Although the invention has been described above with reference to the certain embodiments, the invention is not limited to the embodiments described above. Modifications and variations of the embodiments described above will occur to those skilled in the art, within the scope of the claims.

For example, in the shock absorber 100, the pair of wirings that supply an electric current to the coil 33a passes through the inner periphery of the piston rod 21. Thus, a ground for releasing the electric current applied to the coil 33a to the outside can be eliminated. However, instead of this constitution, the present invention can be constituted such that only a single wiring for applying an electric current to the coil 33a passes through the inside of the piston rod 21 and the wiring is grounded to the outside through the piston rod 21 itself.

The contents of Tokugan 2014-055041, with a filing date of Mar. 18, 2014 in Japan, are hereby incorporated by reference.

1. A magnetic rheological fluid shock absorber utilizing a magnetic rheological fluid that changes a viscosity according to a magnetic field applied, comprising:
a cylinder in which a magnetic rheological fluid is enclosed;
a piston disposed within the cylinder to slide therein and defining a pair of fluid chambers within the cylinder; and
a piston rod connected to the piston and extending to an outside of the cylinder,
wherein the piston comprises:
a piston core formed from a magnetic material and provided with a coil on an outer periphery thereof; and
a ring body formed from a magnetic material and surrounding an outer periphery of the piston core, the ring body and the piston core forming a flow path of the magnetic rheological fluid there-between, and wherein the flow path comprises:
a first flow path part having a predetermined cross-sectional flow area; and
a second flow path part formed to have a larger cross-sectional flow area than the predetermined cross-sectional flow area and a longer axial length than the coil to cover an outer periphery of the coil.

2. The magnetic rheological fluid shock absorber according to claim 1, wherein the second flow path part is formed to face the outer periphery of the coil and the outer periphery of the piston core at both ends of the coil.

3. The magnetic rheological fluid shock absorber according to claim 1, wherein the first flow path part is provided at each of ends of the second flow path part.

4. The magnetic rheological fluid shock absorber according to claim 3, wherein the coil is disposed in the axial center of the second flow path part, and the first flow path parts are formed to have the same length as each other.

5. The magnetic rheological fluid shock absorber according to claim 1, wherein the second flow path part is formed by expanding a diameter of an inner periphery of the ring body.

6. The magnetic rheological fluid shock absorber according to claim 1, wherein the second flow path part is formed by providing an annular recess in the outer periphery of the piston core.

7. The magnetic rheological fluid shock absorber according to claim 1, wherein the second flow path part is formed by expanding a diameter of an inner periphery of the ring body and providing an annular recess in the outer periphery of the piston core.
